(19) United States
(12) Patent Application Publication
(10) Pub. No.: US 2022/0099850 A1
(43) Pub. Date: Mar. 31, 2022

(54) SYSTEM AND METHOD FOR USE IN IMAGING

(71) Applicant: LensFree Ltd., Ra'anana (IL)

(72) Inventors: Zeev ZALEVSKY, Rosh HaAyin (IL); Doron AVRAHAM, Petach Tikva (IL); Yossi DANAN, Rehovot (IL)

(21) Appl. No.: 17/420,965

(22) PCT Filed: Jan. 7, 2020
(86) PCT No.: PCT/IL2020/050017

§ 371 Date: Jul. 6, 2021

Related U.S. Application Data
(60) Provisional application No. 62/789,066, filed on Jan. 7, 2019.

(51) Int. Cl. G01T 1/29

(52) U.S. Cl. CPC G01T 1/295

(57) ABSTRACT

An imaging system is described, the system comprises a radiation source unit comprising one or more emitters for emitting electromagnetic radiation of a selected frequency range toward a general direction of propagation; a detection unit comprising one or more detector arrays located along path of electromagnetic radiation emitted from the radiation source unit; an aperture mask unit located in optical path of radiation propagation from the radiation source unit toward the detection unit, providing minimization factor M with respect to a selected location of a sample to be imaged. The aperture mask unit comprises a set of aperture masks, each carrying a pinhole array comprising predetermined number pinholes with selected arrangement. The pinholes of the set of aperture masks are shifted with respect to alignment of the detector cells by fractions of the minimization factor to generate shifted image replications, shifted by fractions of the geometrical resolution.

### TECHNOLOGICAL FIELD

The invention relates to system and technique for imaging. The invention specifically relates to imaging using pinhole arrays suitable for non-optical frequency ranges such as X-ray and Gamma radiation.

### BACKGROUND

Pinholes provide one of the earliest form of imaging. The basic principles of a pinhole-based imaging system (e.g. pinhole camera) relate to direction of radiation/light rays arriving from one point in the object toward a common location on an image plane. This enables imaging while avoiding the use of refractive lens(es), replacing the lens(es) with a small aperture. More specifically, light arriving from an object passes through the aperture (small pinhole) and projects an inverted image of the region of interest (the object) on the opposite side of the imaging system. This is also known the “camera obscura” effect.

Pinhole optics provides advantages over traditional common lens-based optical systems such as reducing linear distortion, providing virtually infinite depth of focus and wide angular field of view. Additionally, pinhole imaging is useful for non-optical radiation frequencies, such as X-rays, Gamma radiation and basically any wave- or particle-like phenomena.

These advantages typically come with price of reduced brightness associated with small diameter of the aperture as compared with collection area of a lens. However, recently additional imaging techniques enable the use of a plurality of pinholes enabling imaging with increased energetic efficiency and proper image restoration using a selected set of pinhole arrays having suitable arrangement avoiding loss of data that may result from interference of radiation passing through the different pinholes of each array.

Energetic efficiency is a major issue in X-ray and Gamma imaging. The radiation impinging on tissue of any object being imaged may cause various types of damage to the material, being biological or not. In medical imaging applications, reducing the amount of radiation is one of the main requirements from each imaging technique or system.

### GENERAL DESCRIPTION

As indicated above, there is a need in the art for systems and techniques for use in imaging, and specifically in imaging using non-optical wavelength, providing high resolution images with high energetic efficiency. The present invention utilizes pinhole imaging technique, allowing the use of non-optical wavelengths such as X-ray and Gamma radiation, in combination with suitable aperture mask unit to allow imaging with increased resolution using given radiation intensity, or with decreased radiation intensity for providing given resolution.

The present invention is based on an imaging technique utilizing a set of aperture arrays, each aperture array having a selected arrangement of one or more pinholes, in combination with selected alignment of the pinholes with respect to alignment of sensor cells of a detector array. This technique provides efficient imaging with prepared conditions allowing super resolution reconstruction of final image.

Additionally, the present technique is based on magnification or minimization properties associated with pinhole imaging, for increasing energetic efficiency and providing high signal to noise ratio (SNR). More specifically, in some embodiments of the present invention, the aperture mask unit, including the selected set of aperture arrays, is located at a selected position with respect to locations of the sample/tissue and the detector array, to provide selected minimization factor M (e.g. M=2, 3, 4 etc.). In other words, the image formed on the detector array is smaller than the object being imaged by the minimization factor M. Minimization of the image with respect to the object provides increased concentration of the radiation on each sensor cell of the detector array, thereby providing increased energetic efficiency of imaging. This increased radiation intensity comes at a price of reduced resolution, or reduced geometrical resolution, as the number of sensor cells carrying data on the image is lower. This may result in pixelated image where the resolution of the resulting image is reduced.

To this end the present technique utilizes selected alignment of the pinholes in the aperture mask with respect to sensor cells of the detector unit to allow super resolution reconstructions of the collected images. More specifically, assuming a grid formed defined by arrangement of the sensor cells of the detector array is projected onto the aperture mask with the relevant minimization factor M. The pinholes are arranged on the aperture mask with selected shifts with respect to the projected gridlines such that image portion formed by light passing through each pinhole is shifted by fractions of pixels (e.g. sensor cells). As radiation passes through pinholes of an array (e.g. one the arrays used on the aperture mask unit as described in more details below) the radiation forms one or more image replicas on the detector array. Shifting the pinholes to be off-grid with respect to projection of the detector array to the aperture plane, causes the image replicas to be shifted by fractions of sensor cells. Simplifying super-resolution reconstruction of the image to provide resulting reconstructed image having resolution greater than geometrical resolution of the detector array.

Generally, the position of the aperture mask unit for providing minimization of the image with respect to the object/tissue while the detector unit is provided with given geometrical resolution (e.g. similar geometrical resolution that would be used for imaging with no minimization). Minimization of the image provides for more energy impinging per pixel. To provide desired imaging resolution, the arrangement of the aperture mask unit is selected to provide conditions for super-resolution reconstructions, thus providing image data with high resolution while imaging with improved energetic efficiency.

The use and configuration of aperture mask comprising a selected set of aperture arrays is generally described in U.S. Pat. No. 10,033,996. Generally, the imaging system utilizes an aperture mask carrying a selected set of aperture arrays, each having a selected number of pinholes with selected arrangement, such that when imaging using each of the aperture arrays for suitable exposure time a resulting transmission function may be desirably achieved. Specifically, when imaging through an array of two or more pinholes, one or more spatial frequencies of the radiation, that would be transmitted when imaging using a single pinhole, are canceled due to interference between the two or more pinholes. Accordingly, the different aperture arrays of the selected set of aperture arrays are arranged to have transmission functions that cancel different spatial frequencies, to provide total transmission functions having non-zero transmission for all spatial frequencies below selected maximal spatial frequency. The maximal spatial frequency is typically selected by size of the pinholes, limiting the maximal resolution that can be achieved in pinhole imaging.

According to the present technique, cancelation of spatial frequencies caused by using two or more pinholes in an aperture mask provides spectral shaping for the resulting image data. More specifically, the aperture mask unit and the aperture masks thereof embed suitable one or more codes in the radiation passing through the mask, which can enhance the SNR of signals (image) in respect to noise. As described in more details below, the present technique utilizes imaging through a selected number (e.g. N or more) pinholes providing corresponding number of image replications. The pinholes a arranged (shifted) to provide image replications having shifts with respect to the pixel arrangement, providing image replications with different decoding. Thus, the imaging technique is operated with effective exposure time T_{effective} associated with the total number of pinholes multiplied by the actual time of exposure through each pinhole. In some configurations described below, using common exposure time for all aperture masks, the effective exposure time is T_{effective}=Tᵣₑₐₗ×N, where N the total number of pinholes and Tᵣₑₐₗ is the actual time used for exposure. Accordingly the Tᵣₑₐₗ may be short with respect to alternative techniques due to the SNR enhancement, reducing radiation exposure to the object/tissue being imaged.

Generally, the aperture mask unit may be configured for replacing the aperture arrays for imaging using each one of the aperture array with selected corresponding exposure time. In some configurations of the present invention, the aperture mask unit may comprise the set of aperture arrays together, to provide simultaneous exposure using all of the aperture arrays. To this end, the aperture mask unit comprises a set of aperture arrays arranged to provide overlap between image replicas formed by radiation passing pinholes of an aperture of a certain array at the image plane (selected by providing minimization factor M). This is while the different arrays are arranged at suitable distances between them eliminate or at least significantly reduce overlap between image replicas formed by radiation passing through pinholes of different aperture arrays.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a system for imaging according to some embodiments of the present invention;

FIG. 2 exemplify fractional shifts of pinholes in the aperture arrays and condition of super-resolution reconstructions according to some embodiments of the invention;

FIG. 3 exemplifies an aperture mask unit formed of three aperture masks according to some embodiments of the present invention; and

FIG. 4 exemplifies an aperture mask unit configured for simultaneous imaging using different aperture masks according to some embodiments of the invention;

FIGS. 5A to 5D show experimental results of imaging an element comparing conventional X-ray imaging (FIGS. 5A and 5B) and imaging using the present technique (FIGS. 5C and 5D);

FIGS. 6A to 6C show GEANT simulation results, FIG. 6A show simulation according to the conventional X-Ray imaging technique using reference radiation dose, FIG. 6B shows simulation according to conventional X-ray imaging technique with 25% of the reference radiation dose, and FIG. 6C shows simulation according to the present technique with 25% of reference radiation dose; and

FIGS. 7A to 7C show additional GEANT simulation results, FIG. 7A show simulation according to the conventional X-Ray imaging technique using reference radiation dose, FIG. 7B shows simulation according to conventional X-ray imaging technique with 25% of the reference radiation dose, and FIG. 7C shows simulation according to the present technique with 25% of reference radiation dose.

### DETAILED DESCRIPTION OF EMBODIMENTS

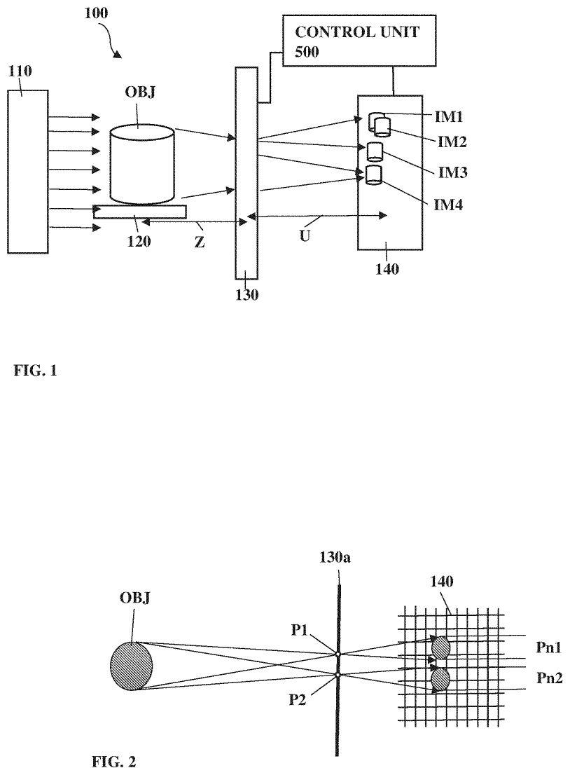

Reference is made to FIG. 1 schematically illustrating a system 100 for imaging according to some embodiments of the invention. The system 100 includes a radiation source 110, sample mount 120 or generally a dedicated location for positioning a sample OBJ or tissue for imaging, aperture mask unit 130 and detector array 140. As illustrated in FIG. 1, the system is configured to provide imaging of an object (or tissue) OBJ on the detector array 140, using radiation emitted from the radiation source 110. Generally, in some configurations, the system 100 may also include, or be associated with/connectable to, a control unit 500. The control unit 500 is generally configured for controlling operation of the aperture mask unit 130 and for receiving image data pieces from the detector array 140 and providing selected reconstructions of the image data pieces as described further below.

The radiation source 110 is configured for emitting radiation (generally electromagnetic or wave-like radiation) of selected wavelength range, which typically may be non-optical wavelength range such as X-ray or gamma radiation. In some configurations, the radiation source may be configured for emitting ultrasound radiation. The radiation source 110 may also include a diffuser element mounted in path of radiation emitted toward the desired general direction of propagation to the object OBJ (specified by location of sample mount 120). Further, the radiation source 110 may include one or more radiation blocking/absorbing walls configured for preventing radiation emission toward directions other than the desired general direction of propagation toward the object OBJ.

The sample mount 120 as described herein refers to a selected location designated for positioning of an object, body part or tissue for imaging by the system 100. The sample mount 120 may be physical mount such as shelf, table or any other mechanical configuration for holding one or more objects (being biological or not) in selected position, or it may define selected space where such object of tissue is to be positioned for optimal imaging performance.

The aperture mask unit 130 is formed of one or more aperture masks configured to block propagation of radiation, while allowing radiation to propagate through one or more pinholes in the mask forming corresponding one or more image portions exemplified by IM1 to IM4 on the detector array 140. The aperture mask unit 130 generally includes a set of two or more aperture masks, each carrying an array of one or more pinholes with selected arrangement. Generally, the use of a pinhole array in an pinhole array mask provide transmission function having one or more spatial frequencies with zero transmission, due to interference of radiation between the apertures/pinholes. The two or more aperture masks used in the aperture mask unit 130 have pinhole arrangements characterized with different spatial frequencies being suppressed in the transmission functions thereof. Thus, the use of two or more aperture arrays provide efficient imaging collecting generally all spatial frequencies of the objects, up to maximal spatial frequency determined by diameter of the pinholes. More specifically, arrangement of apertures in the aperture masks provides selected total number of aperture where each aperture mask includes an array of one or more apertures such that transmission function of each aperture mask cancels different spatial frequencies to provide a total transmission function with non-zero transmission for all spatial frequencies below selected maximal spatial frequency (generally defined by minimal diameter of the pinholes).

According to the present technique, the aperture mask unit 130 is positioned at selected distance Z from the object mount 120 and distance U from the detector array 140. The distances Z and U are selected to provide desired minimization factor M (corresponding to magnification factor of I/M) given by M=Z/U. Minimization of the image with respect to the object OBJ provides increased energetic concentration, associated with radiation intensity collected by each sensor cells of the detector array 140. This is associated with smaller spreading of energy (taking smaller area of the detector array) for given solid angle, resulting in increased signal to noise ratio of radiation detection. Generally, however, such improved energetic efficiency may be associated with reduced image resolution, as there are less sensor cells of the detector array that participate in imaging of a given solid angle. To this end the present technique further utilizes selected arrangement of the pinholes in the aperture mask unit 130 for providing suitable conditions and simplifying super resolution reconstructions of the image data. More specifically, the different pinholes of the aperture mask unit 130 (the set of two or more aperture masks thereof) are positioned is selected locations, shifted with respect to alignment of detector cells of the detection unit 140 by fractions of the minimization factor M.

The respective shifts of the different pinholes result in image portions/replications provided by each of the pinholes falling on different sensor cell arrangements. This is illustrated in FIG. 2 exemplifying imaging of an object OBJ using aperture mask 130a onto a detector array 140. The aperture mask in this example includes two pinholes P1 and P2. The pinholes P1 and P2 are positioned to provide misalignment between arrangement of the pinholes and arrangement of the pixels of detector array 140 along at least one axis, i.e. the arrangement of pinholes P1 and P2 is shifted with respect to alignment of detector cells of detection unit 140 by fractions of the minimization factor M. As shown, radiation components propagating through pinhole P1 generate image Pn1 on the detector array, which is formed of radiation intensity collected by sensor cells of three rows (along the vertical axis). This is while radiation components propagating through pinhole P2 generate image Pn2 formed by radiation intensity collected by sensor cells of two rows. Thus, the shifts in alignment of pinholes P1 and P2 generate shifts in the number of pixels collecting the respective image portions. This provides imaging conditions enabling improved super resolution reconstruction of the collected image data, as the different image portions (Pn1 and Pn2 in this example) are imaged by different number of pixels. Preferably, to provide optimized conditions for super resolution reconstructions, the aperture mask unit may include total number of at least M² pinholes, arranged in the two or more aperture masks (aperture arrays), such that each pinhole is shifted by (l/M, k/M) with respect to projected alignment of the detector array onto the aperture mask unit, where l and k are integers in the range 0 and M−1.

As indicated above, the collection mask unit 130 includes a set of selected number or two or more aperture masks, each having an array of pinholes including one or more pinholes with selected arrangement. More specifically, the aperture mask unit may be configured for switching between the set of two or more aperture masks and use each aperture mask for certain selected exposure time. Alternatively, in some embodiments of the present invention, the aperture mask unit may be formed of a mask unit carrying the selected set of two or more aperture masks located on a common mask. In this configuration, the different pinhole arrays are arranged to allow overlap in image portions collected through pinholes of the same array (of the same aperture mask) while provide spatial separation between image portions collected through pinholes of different arrays (different aperture masks).

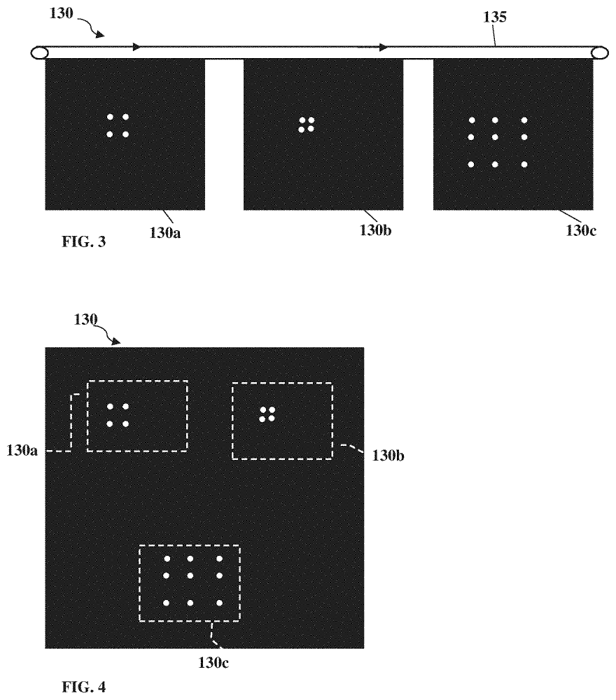

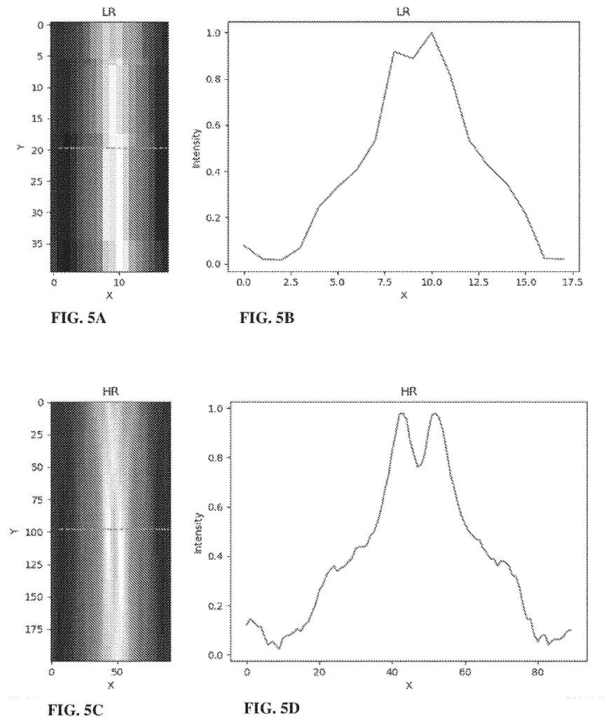

In this connection reference is made to FIG. 3 illustrating an aperture mask unit 130 configured for changing of the aperture masks (e.g. 130a, 130b and 130c) allowing usage of first exposure time for the first mask 130a, second exposure time for the second mask 130b and third exposure time for the third mask 130c. As shown the aperture mask unit 130 is exemplified in this figure with three aperture masks 130a, 130b and 130c, and a mask switching mechanism 135. The switching mechanism 135 is illustrated as a mechanical switching mechanism for simplicity and may be any type of switching mechanism, including digital control on MEMS providing variation of the pinhole arrays in accordance with selected arrangement so the different aperture masks.

The aperture masks 130a-130c may be formed of radiation blocking material having an array of one or more pinholes with selected arrangement. As indicated above, the pinholes are arranged in accordance with projection of the arrangement of the detector sensor cells on the aperture mask unit. This projection is associated with the relative positions of the sample mount 120, aperture array 130 and detector unit 140, and according the minimization factor M. Further, the different pinholes are shifted with respect to gridlines associated with projection of the detector array 140 as described above.

It should be noted that the switching mechanism 135 illustrated in FIG. 3 is an exemplary mechanism and various other configurations may be used, such as described in U.S. Pat. No. 10,033,996. For example, the different aperture masks may be mounted on a rotating wheel, allowing switching between the aperture masks by rotation of the aperture mask unit. Additional configurations may be used replaceable masks or any other technique. In some other configurations the aperture mask unit may be configured for electronically vary transmission via the different pinhole, e.g. using a MEMS patterned plate varying location of the pinholes therein.

Aperture mask unit configurations using switching of the aperture masks allows adjustment to the total transmission function to provide improved transmission of selected spatial frequencies. However, this configuration requires usage of the control unit for controlling operation of the radiation source 110 and the aperture mask unit for imaging the object using the different aperture masks with corresponding (being equal or different) exposure times and preventing emission of radiation during replacing of the aperture masks.

In some other configurations, the aperture mask unit may carry the selected set of aperture masks providing simultaneous exposure and imaging using the different aperture masks. This is exemplified in FIG. 4 illustrating an aperture masks unit configured of radiation blocking material and having an arrangement of pinholes in three (generally two or more) arrays 130a, 130b and 130c. The pinhole arrays are located on the aperture mask unit at selected positions and distance between the aperture such that radiation transmitted from the object through pinholes of different arrays does not overlap within propagation distance U toward the detector array. This is while pinholes of the same array do allow overlap of radiation transmitted through the different pinholes of the array (e.g. array 130b) within propagation distance U toward the detector unit. This configuration is useful when imaging with minimization of the image with respect to the object, as the distance, and variation of point of view of the different pinholes may be relatively small while avoiding overlap in radiation at the image plane.

The aperture mask unit 130 configuration exemplified in FIG. 4 may also provide increased energetic efficiency in imaging. such energetic efficiency is associated in reduced exposure time required for imaging as the different aperture arrays are used simultaneously for imaging to provide two or more sets of overlapping image portions on the detector array. For example, in the case of three aperture masks, using the different masks sequentially with exposure time of 0.3 seconds each requires total exposure time of 0.9 seconds. This is while the aperture mask unit of FIG. 4 may provide similar imaging conditions using exposure time of 0.3 seconds for the three aperture masks simultaneously. Generally however, this configuration may be better employed using relatively large detector array 140, sufficiently large for capturing the different image replications with no spatial overlap between image replications formed by different arrays 130a, 130b and 130c.

As indicated above, system of the present technique may include or be associated with a control unit. The control unit is configured for receiving image data portions collected by the detector array 140 and for processing the image data portions for reconstruction of image data of the object OBJ. The reconstruction of the resulting image based on image data portions is described in U.S. Pat. No. 10,033,996 and utilizes data on the arrangement of the pinholes of the set of aperture arrays. Further, according to the present technique, the control unit may apply one or more super-resolution processing technique, utilizing shifts in image portions as exemplified in FIG. 2 for providing resulting image having resolution greater than geometrical resolution of the detector array. Thus, the present technique provides for imaging, e.g. using non-optical radiation, with increased energetic efficiency, thereby reducing the amount of radiation impinging on the object, for example on the patient in the case of medical X-ray imaging.

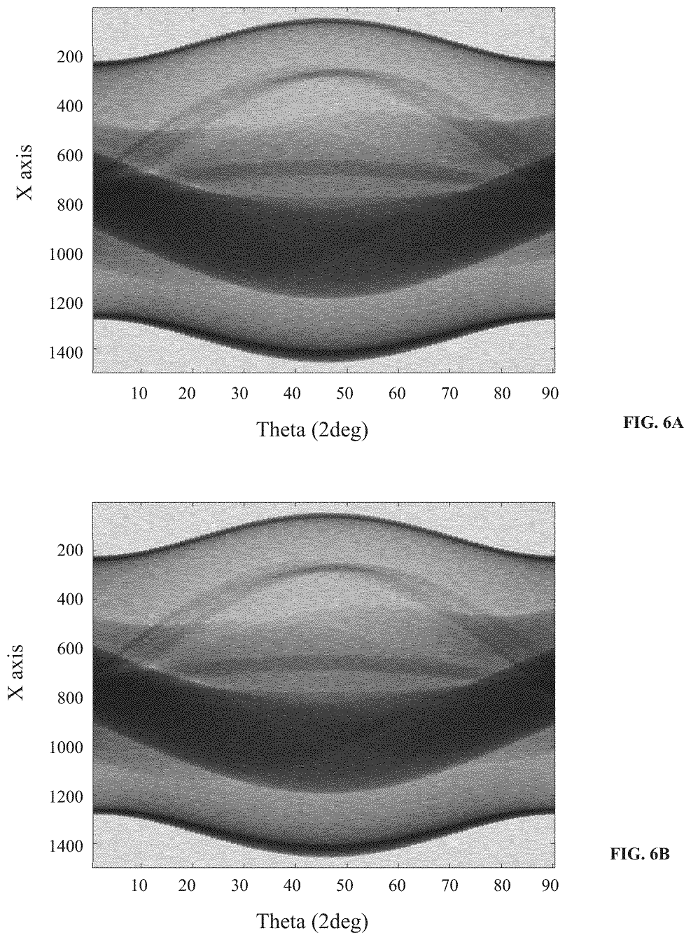

Reference is made to FIGS. 5A to 5D showing experimental results in X-ray imaging of a sample formed by two nails located at distance of 2.5 mm between them within a uniform acrylic phantom of diameter of 27 mm. FIGS. 5A and 5B show respectively reconstructed image and a cross section graph of the image obtained using conventional X-ray imaging technique, and FIGS. 5C and 5D show respectively the reconstructed image and corresponding cross section graph for image collected and reconstructed according to the present technique.

The image data shown in FIGS. 5C and 5D was collected using two pinhole arrays having respectively 1, and 2 pinholes, arranged with one-dimensional geometry. The pinholes are shifted by ±⅓ of pixel with respect to the arrangement of pixel array used for collection of the radiation. The aperture arrays and detector array were placed to provide minimization factor of 3 (i.e. the resulting image is of third of the size of the actual object. Generally, in this example, the resulting image is a simple sum of the collected image data pieces.

As shown in FIGS. 5B and 5D, the conventional X-ray imaging technique is limited in providing sufficient image resolution. This is while the present technique provides imaging that can identify the different nails of the sample and determine the internal structure of the sample.

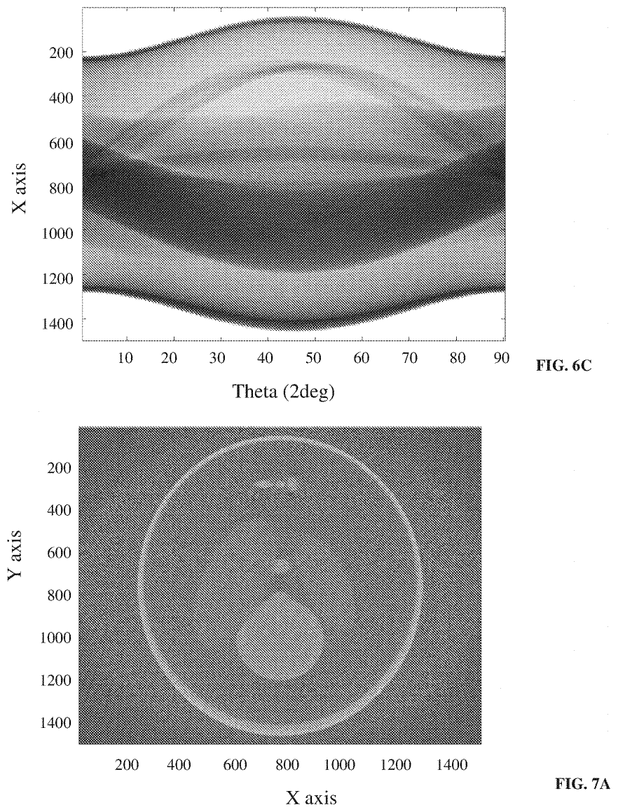

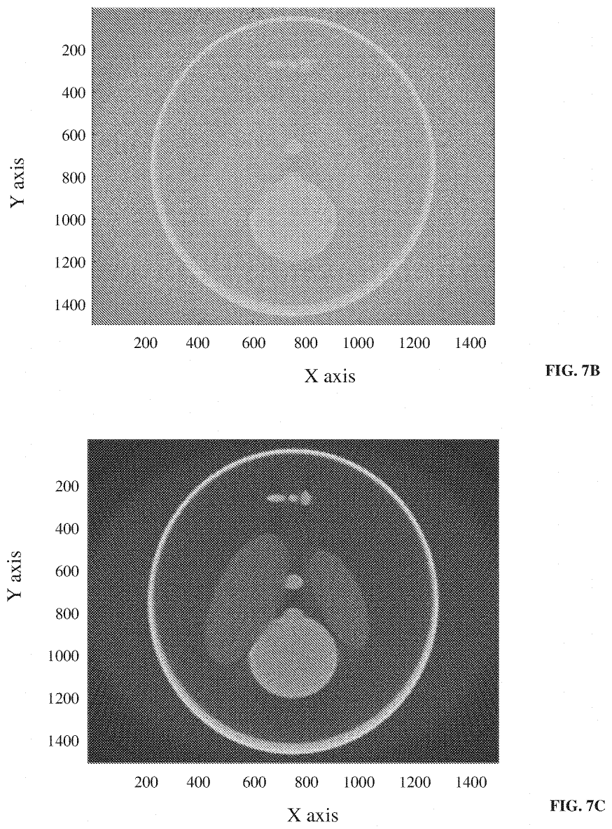

Additionally, reference is made to FIGS. 6A to 6C and 7A to 7C showing Geant4 CT simulation results for imaging using conventional X-ray techniques at reference (high) radiation dose (FIGS. 6A and 7A), imaging using the convention X-ray imaging techniques with reduced (25%) radiation dose (FIGS. 6B and 7B), and imaging and image reconstructions according to the present technique with reduced (25%) radiation does (FIGS. 6C and 7C). the simulations shown in FIGS. 6C and 7C were conducted using aperture array masks having total number of 4 pinholes arranged with alignment shifts of 0, ¼, ½, and ¾ with respect to alignment of pixels in the detector array. The simulation used minimization factor of 4, i.e. the image collected is fourth of the object being observed. As can be seen in FIGS. 6B and 7B, using reduced radiation dose in the conventional imaging technique results in reduced image contrast and general image quality. This is while the use of the present technique, associated with imaging through a selected set of aperture arrays, where the apertures are shifted with respect to alignment of pixels of the detector array, and determining the resulting image based on sum of the collected image pieces to provide super-resolution reconstruction of the collected image data, provides improved image quality as shown in FIGS. 6C and 7C, even when using reduced radiation dose.

Thus, the present invention provides a system and technique for imaging using a selected arrangement of pinhole arrays. The present technique utilizes shifts in alignment of the pinholes within the arrays, and magnification/minimization of the imaging for collecting image data having improved conditions for super resolution reconstruction. This enables imaging with increased image resolution and may allow reducing radiation does transmitted onto an object for imaging.

1. An imaging system comprising:
a radiation source unit comprises one or more emitters configured for emitting electromagnetic radiation of a selected frequency range toward a general direction of propagation;
a detection unit comprises one or more detector arrays having selected geometrical resolution and located along path of electromagnetic radiation emitted from said radiation source unit;
an aperture mask unit located in optical path of radiation propagation from said radiation source unit toward said detection unit to provide minimization factor M with respect to a selected location of a sample to be imaged, said aperture mask unit comprising a set of aperture masks, each carrying a pinhole array comprising predetermined number pinholes with selected arrangement;
wherein pinholes of said set of aperture masks are shifted with respect to alignment of detector cells of said detection unit by fractions of said minimization factor to thereby generate on said detection unit shifted image replications, being shifted by fractions of said geometrical resolution.

2. The system of claim 1, wherein total number of pinholes is said set of aperture masks is N, being at least M\hat{ }2, each pinhole being shifted by (l/M, k/M) with respect to grid lines defined by projection of arrangement of detector elements of said detector unit, where l and k are integers in the range 0 and M−1.

3. The system of claim 1, wherein said minimization factor M is greater than 1, providing image smaller is size with respect to size of the sample, thereby allowing increased image contrast for given radiation used for imaging.

4. The system of claim 1, further comprising a control unit connected to said detection unit, the control unit comprises at least one processing utility configured for receiving image data from the detection unit and for processing said image data in accordance with data on arrangement of pinholes in said set of aperture masks to determine reconstructed image of a sample being imaged and for utilizing data on said shifted image replications for applying one or more super-resolution processing generating reconstructed image data having resolution greater than geometrical resolution of said detector array.

5. The system of claim 4, wherein said control unit further comprises a mask coding module connected to said aperture mask unit and configured for changing aperture mask from said set of aperture masks in accordance with selected encoding scheme.

6. The system of claim 4, wherein said control unit comprises a memory utility comprising pre-stored data on relative alignment of pinholes in arrays of said set of aperture marks with respect to alignment of said detector array.

7. The system of claim 4, wherein said control unit comprises image reconstructions module configured for receiving a set of image data pieces collected using said set of aperture masks respectively and for determining a reconstructed image of the sample using data on arrangement of the corresponding pinhole arrays and relative shift of pinholes with respect to alignment of said detector array.

8. A method for use in pinhole imaging, the method comprising: directing radiation toward a sample to be imaged with a general direction of radiation propagation, providing a detection unit comprising at least one array of detector cells with certain geometrical resolution at a selected location downstream along said general direction of radiation propagation, and providing an aperture mask unit comprising a set of aperture masks, each carrying a pinhole array comprising predetermined number pinholes with selected arrangement, at selected location between said sample and said detector unit for providing selected imaging minimization factor M, wherein said providing an aperture mask unit comprises arrangement of pinholes of said set of aperture masks with selected shifts with respect to alignment of detector cells of said detection unit, said selected shifts being fractions of said minimization factor to thereby generate on said detection unit shifted image replications, being shifted by fractions of said geometrical resolution.

9. The method of claim 8, further comprising collecting a set of image data pieces corresponding with said set of aperture masks, and processing said set of image data pieces for determining reconstructed image data indicative of the sample in accordance with data on arrangement of the corresponding pinhole arrays and relative shift of pinholes with respect to alignment of said detector array.

10. The method of claim 8, wherein said selected shifts correspond to pinholes arrangement shifted by (l/M, k/M) with respect to grid lines defined by projection of arrangement of detector elements of said detector unit, where l and k are integers in the range 0 and M−1.

11. An imaging system comprising radiation emission unit configured for emitting electromagnetic radiation with general direction of propagation toward a sample mount, detection unit comprising at least one detector array, and aperture mask unit, the aperture mask unit comprises a predetermined arrangement of aperture arrays being spatially separated to allow overlap of radiation transmitted through apertures of each array, while prevent overlap in radiation transmitted through apertures of different arrays of said set.

12. The imaging system of claim 11, further comprising a control unit configured for receiving image data collected by said detector unit and for processing said image data for determining reconstructed image of an object located on said sample mount, said processing comprises determining within said image data a set of spatially separated image data piece associated with radiation transmitted through said sat of non-overlapping aperture arrays, and for processing said set of image data pieces in accordance with data on arrangement of said aperture arrays.
